(19) United States
(12) Patent Application Publication
(10) Pub. No.: US 2023/0197042 A1
(43) Pub. Date: Jun. 22, 2023

(54) AUTOMATED GENERATION OF AUDIO TRACKS

(71) Applicant: Soundful, Inc., San Diego, CA (US)

(72) Inventors: Diaa El All, San Diego, CA (US); Aaron Dawson, Minneapolis, MN (US); Josh Groen, San Diego, CA (US)

(21) Appl. No.: 18/082,988

(22) Filed: Dec. 16, 2022

Related U.S. Application Data
(60) Provisional application No. 63/292,333, filed on Dec. 21, 2021.

(51) Int. Cl. G10H 1/00

(52) U.S. Cl. CPC G10H 1/0025; G10H 2210/151; G10H 2210/381; G10H 2210/565; G10H 2250/005; G10H 2240/125; G10H 2240/131; G10H 2210/105; G10H 2220/116

(57) ABSTRACT

Conventionally, significant time and effort are required to construct audio tracks. Disclosed embodiments enable automation of audio tracks using templates that associate sound generator(s) with template section(s). Each template enables a model to automatically generate unique audio tracks in which the sections and/or sounds are probabilistically determined. Certain embodiments introduce additional variability into the automated generation of audio tracks. In addition, the model may generate the audio tracks, note by note, to ensure that no copyrights are infringed.

### CROSS-REFERENCE TO RELATED APPLICATIONS

This application claims priority to U.S. Provisional Patent App. No. 63/292,333, filed on Dec. 21, 2021, which is hereby incorporated herein by reference as if set forth in full.

### BACKGROUND

### Field of the Invention

The embodiments described herein are generally directed to audio composition, and, more particularly, to the automated generation of audio tracks.

### Description of the Related Art

Typically, a lot of time and effort is required to construct a new audio track. This is exacerbated when, as is often the case, the author hits a creative block or does not have the training or expertise to construct an audio track. To overcome such a creative block, an author may start constructing a melody using musical loops. However, this risks infringing another author's copyrights, for example, when the author is consciously or subconsciously utilizing a musical loop that the author has heard elsewhere.

### SUMMARY

Accordingly, systems, methods, and non-transitory computer-readable media are disclosed for automated generation of audio tracks, according to a set of parameters specified in a template. Not only do the disclosed embodiments enable automated generation of audio tracks, but they may apply a model to the template to construct the audio track note by note, so that there is no risk of infringing someone's copyrights.

In an embodiment, a method comprises using at least one hardware processor to: acquire a template, wherein the template comprises one or more template sections that are each associated with one or more sound generators; apply a model to the template to generate an audio track from the template by, for each of at least a subset of the one or more template sections, generate an audio section, note by note, using at least a subset of the one or more sound generators associated with that template section; and output the audio track in an output format.

Each of the one or more template sections may be associated with a probability vector that defines a probability value for each of the one or more sound generators associated with that template section. Each probability value for one of the one or more sound generators in each probability vector may represent a likelihood that the sound generator will be used to generate the audio section for the template section associated with that probability vector.

The template may comprise one or more template parameters, and the model may generate the audio track according to the one or more template parameters. The one or more template parameters may comprise one or both of a speed or a musical key.

The one or more template sections may be a plurality of template sections. The method may further comprise using the at least one hardware processor to determine an arrangement of the plurality of template sections. The plurality of template sections may be associated with probability values, and the at least one hardware processor may determine the arrangement of the plurality of template sections based on the probability values.

The one or more sound generators, associated with each of the one or more template sections, may be a plurality of sound generators.

Each of the one or more sound generators, associated with each of the one or more template sections, may be defined by one or more sources, one or more rhythms, and an algorithm that generates a one-shot, representing a note, based on the one or more sources and the one or more rhythms. Each algorithm may be associated with one or more algorithm parameters, and each algorithm may generate the one-shot according to the one or more algorithm parameters. At least one of the one or more sound generators, associated with at least one of the one or more template sections, may be associated with one or more effects, and the algorithm of the at least one sound generator may generate the one-shot to have at least one of the one or more effects.

The template may represent a sub-genre of a musical genre.

Acquiring the template may comprise: receiving a selection of the template from a plurality of templates stored in a database; and retrieving the template from the database. The template may comprise one or more template parameters, the model may generate the audio track according to the one or more template parameters, and acquiring the template may further comprise: generating a graphical user interface that comprises one or more inputs for specifying a value of each of at least a subset of the one or more template parameters; and receiving the value of at least one template parameter via the one or more inputs.

The method may further comprise using the at least one hardware processor to, for each of the plurality of templates: generate a screen with one or more inputs for defining the template; receive a definition of the template via the one or more inputs; and store the defined template in the database. The screen may comprise a matrix with two dimensions, a first one of the two dimensions may represent each sound generator that is associated with the one or more template sections, and a second one of the two dimensions may represent each of the one or more template sections.

Applying the model may be implemented by a first microservice, and outputting the audio track may comprise rendering the audio track by a second microservice that is independent from the first microservice.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a template from which an audio track may be automatically generated, according to an embodiment;

FIG. 4 illustrates a process for automated generation of an audio track, according to an embodiment;

FIG. 5 illustrates an example screen that may be used to define a template, according to an embodiment; and

FIG. 6 illustrates an example subprocess that applies a model to a template to generate an audio track, according to an embodiment.

### DETAILED DESCRIPTION

In an embodiment, systems, methods, and non-transitory computer-readable media are disclosed for automated generation of audio tracks. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. Example Infrastructure

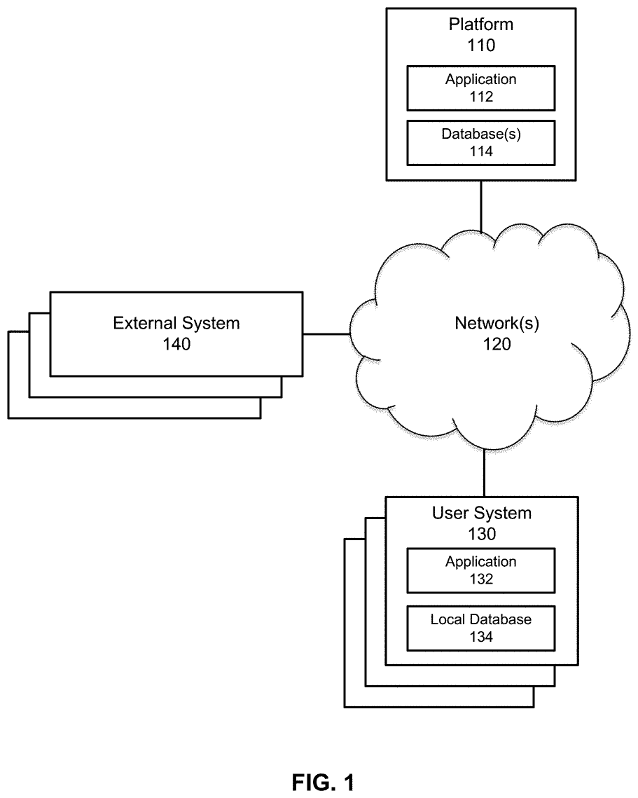

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would comprise the personal computer, mobile device (e.g., smart phone, tablet computer, etc.), or professional workstation of an end user seeking to create a new audio track or an administrative user managing the functionality of platform 110. Each user system 130 may comprise or be communicatively connected to a client application 132 and/or one or more local databases 134.

External system(s) 140 may also comprise any type or types of computing devices capable of wired and/or wireless communication. However, it is generally contemplated that an external system 140 would comprise a server system that may receive data from platform 110 and/or transmit data to platform 110. For example, an external system 140 may be a social networking site that invites users to post social media, another website which invites users to post audio tracks, an online marketplace on which audio tracks may be exchanged or sold, a site for remixing or otherwise editing audio tracks and/or combining audio tracks, or the like. In this case, an end user may utilize platform 110 to generate an audio track, and then share the audio track on external system 140. Sharing the audio track may comprise server application 112 posting the audio track on the external system 140 (e.g., in an association with a user account of the end user on external system 140), via an application programming interface (API) provided by external system 140.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation My SQL™, Oracle™ IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an API which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

2. Example Processing Device

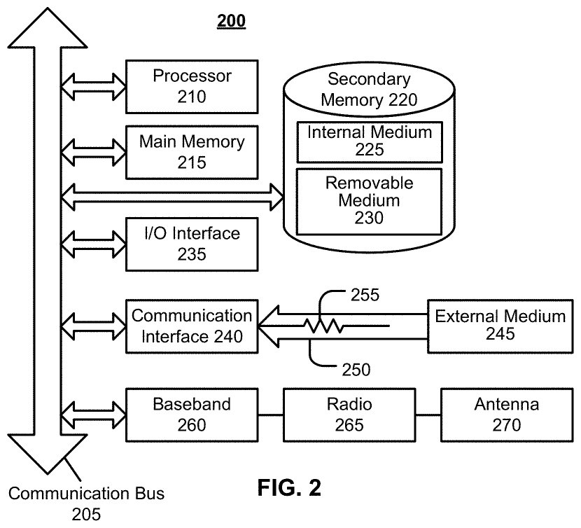

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Python, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

3. Template

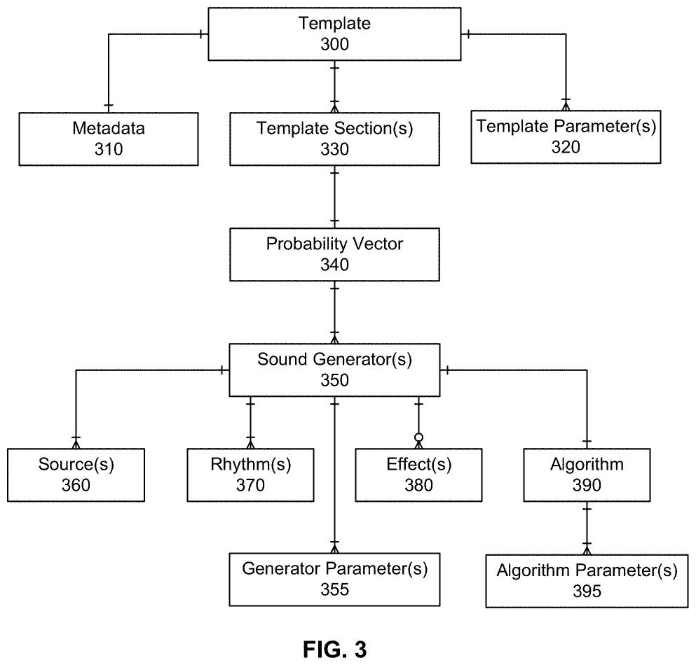

FIG. 3 illustrates a template 300 from which an audio track may be automatically generated, according to an embodiment. Each template 300 may define one or a plurality of template sections 330, to be converted into an audio track, according to one or a plurality of template parameters 320, and be configured to generate metadata 310 for the audio track. In alternative embodiments, one or more of these components may be omitted and/or template 300 may comprise or otherwise define additional components. In any case, each template 300, managed by platform 110, may be represented by a standardized data structure (e.g., Python source code), which may be maintained in database(s) 114. Advantageously, templates 300 can be used to package any artist, band, musical genre or sub-genre, musical time period, musical style, or other class of sound as a set of attributes, which can be subsequently used to automatically and repeatedly generate audio tracks representing that packaged sound.

Metadata 310 may comprise a name, description, author, time of creation, and/or the like. It is generally contemplated that a single template 300 would represent a specific sub-genre of a music genre. For example, music genres may include hip hop, pop, electronic dance music (EDM), rhythms and blues (RnB), Latin, ambient, social media (e.g., representing background music for social media apps, such as TikTok™), and/or the like. A sub-genre of one of these music genres may represent a specific focus, one or more specific characteristics, and/or the like of the music genre. For example, sub-genres of the hip-hop music genre may include club beats, dark plano trap, dreamy trap, emo guitar trap, emotional trap, low-fidelity chill, low-fidelity dreamy, low-fidelity vibey, mafia trap, melodic drill, New York drill, old school, soul trap, trap, virtual trap, world trap, and/or the like. Each template 300 may package together attributes of a particular sub-genre of a particular music genre.

Template parameter(s) 320 may comprise values for one or more musical characteristics to be used when generating an audio track from template 300. For example, parameter(s) 320 may comprise a music genre, minimum beats per minute (BPM), maximum beats per minute, default beats per minute, tempo, list of keys, list of chord progressions, mood, whether or not to use loops, pattern type, and/or the like.

Template section(s) 330 represent the temporal audio sections of the audio track to be generated from template 300. Generally, a template 300 will comprise a plurality of template sections 330. For example, template section(s) 330 may comprise an introduction, one or more verses, one or more choruses, one or more breaks, an outro (i.e., closing), an outro impact, and/or the like. Template 300 may define the duration of each template section 330. Different template sections 330 may have the same or different durations, and may be named in any suitable manner. In the event that template 300 comprises a plurality of template sections 330, template 300 may also define the order of template sections 330. In this case, template sections 330 collectively define the temporal structure of the audio track to be generated, such that any audio track generated from a given template 300 will have an audio section for every template section 330 in that template 300.

In an alternative embodiment, template 300 may probabilistically define template sections 330. For example, each template section 330 may be associated with a probability of whether the template section 330 is to be included or omitted from the audio track generated from template 300, a probability as to the number of times that the template section 330 (e.g., verse or chorus) is to be used in the audio track generated from template 300, a probability for the duration of the template section 330 (e.g., a probability distribution for a range of durations), a probability related to the position of the template section 330, relative to other template sections 330, within the overall audio track, and/or the like.

In addition, each template section 330 may be associated with a probability vector 340. The probability vector 340 for a given template section 330 comprises probability values for one or a plurality of sound generators 350 that can be used for that template section 330. Probability values in probability vector 340 may be associated one-to-one with a sound generator 350. Each probability value represents the probability that the associated sound generator 350 will be used during generation of the associated template section 330 for an audio track being generated from template 300. In other words, probability vectors 340 probabilistically map template sections 330 to sound generators 350.

A probability value in each probability vector 340 may be defined in a range between 0%, indicating that the associated sound generator 350 will never be used to generate a one-shot audio sample in the associated template section 330, and 100%, indicating that the associated sound generator 350 will always be used to generate a one-shot audio sample in the associated template section 330. It should be understood that the probability value may be any value between 0% and 100%, including 0% and 100%. Whenever the probability value is greater than 0%, the associated sound generator 350 is eligible to be considered for generating a one-shot audio sample in the associated template section 330 of the template 300 being used to generate an audio track. However, whenever the probability value is less than 100%, there is the possibility, in proportion to the probability value, that the associated sound generator 350 may not be used to generate the one-shot audio sample in the associated template section 330 of the template 300 being used to generate the audio track.

Sound generators 350 can be considered the backbone to the automated generation of audio tracks. Each sound generator 350 may generate a granule of audio. In an embodiment, each sound generator 350 generates a one-shot. A “one-shot” is an audio sample of a single strike, note, chord, or other sound effect. However, in an alternative embodiment, each sound generator 350 could generate a less granular audio sample. It should be understood that an audio sample may comprise a sound produced by a musical instrument, such as the strike of a particular type of drum, the strum of a particular type of guitar, a note from a horn, and/or the like, or by a human (e.g., singing a note, speaking a character, etc.). However, an audio sample may also comprise other types of sound, such as the rustling of leaves or papers, a dripping faucet, the bark of a dog, breaking glass, a car honking, a rainfall, a conversation, and other sounds from everyday objects or surroundings. Essentially, a sound generator 350 can be created to generate an audio sample for virtually anything that produces sound. As used herein, the term “audio sample” refers to a composition of one or more one-shots, and the term “audio track” refers to a full musical composition, which will generally comprise a plurality of one-shots.

Each sound generator 350 may comprise one or a plurality of sound sources 360, one or a plurality of rhythms 370, one, zero, or a plurality of effects 380, and an algorithm 390 that combines one or more of a source 360, rhythm 370, or effect 380 into a one-shot, according to one or more algorithm parameters 395. More generally, sound generator 350 defines how a sound is generated according to specified parameters and behaviors. Examples of sound generators 350 include, without limitation, an offbeat tom, hats, psy trance bass, pluck bass, string bass staccato, guitar chords, trance pluck synth, trance kick, pluck lead, electric guitar melody, cello chords, viola arpeggio, muted guitar arp, trombone chords, rain drum, E plano arp, acoustic guitar chords, vocal chop melody, soft short pad, hip hop lead fill, acoustic plano sustain, hip hop arp, synth bass pad, clap tight, electric plano sustain, hip hop open hat, and/or the like.

A source 360 may comprise a sample bank that includes one or a plurality of audio files that may be used by algorithm 390 as a basis to generate a new one-shot. For example, the audio file(s) in a sample bank may comprise a sample of a staccato from each of a plurality of related musical instruments (e.g., variations of the same instrument) and/or different musical instruments. In an embodiment, a plurality of sample banks may be grouped into a collection, which may be associated with a sound generator 350 as a single source 360 comprising all of the plurality of sample banks in the collection. Alternatively or additionally, source 360 may comprise a synthesizer that generates a sound in real time (e.g., a white noise generator), as opposed to audio file(s).

The audio files in the sample bank of a source 360 may represent one-shots, round-robin audio samples, looping audio samples, instrumental audio samples, and/or the like. In order to add a new audio file to a sample bank, an administrative user may record or import an audio sample, listen to the audio sample to ensure adequate quality, use a digital audio workstation (DAW) or similar system to sample different notes into one or more audio samples to be added to the sample bank, render the audio sample(s) into audio file(s), export the rendered audio file(s) from the DAW or similar system, and import the exported audio file(s) into the sample bank using the graphical user interface of server application 112.

A rhythm 370 defines a single sequence of musical notes that may be used by algorithm 390 when generating an audio sample. In an embodiment, a plurality of rhythms 370 may be bundled into a collection, which may be associated with a sound generator 350 as a single unit comprising all of the plurality of rhythms 370 in the collection. Alternatively or additionally, rhythm 370 may comprise an algorithm that generates a sequence of musical notes in real time. Each rhythm 370 may be defined by a velocity, a rhythm note with a note position, a note length, a measure, and a subdivision, for a sequence of musical notes.

An effect 380 defines an audio effect that may be applied by algorithm 390 when generating an audio sample. Effect(s) 380 may include, without limitation, filtering, delay, compression, equalization, gain, panning, and/or the like. In an embodiment, a plurality of effects 380 may be bundled into a collection, which may be associated with a sound generator 350 as a single unit comprising all of the plurality of effects 380 in the collection. Effect(s) 380 may be applied after algorithm 390 has produced a one-shot based on at least one source 360 and at least one rhythm 370.

Each algorithm 390 may be associated with one or more algorithm parameters 395. Algorithm parameter(s) 395 may include, without limitation, a pattern type (e.g., arpeggio, bassline, chord pattern, fast melody, slow melody, percussion, etc.), a chord progression, a load speed, a scale, a transposition amount, a Musical Instrument Digital Interface (MIDI) range, a velocity map, a legato note length, and/or the like.

Each sound generator 350 may also be associated with one or more generator parameters 355. Generator parameter(s) 355 may include, without limitation, tempo, voicing, octave, key, and/or the like.

In essence, each sound generator 350 may be considered an algorithm 390 that generates an audio sample that combines one or more sources 360 with one or more rhythms 370 and zero or more effects 380, according to algorithm parameter(s) 395 and generator parameter(s) 355. A sound generator 350 may be created by an administrative user for each instrument or other sound source that is to be usable in a template 300. A sound generator 350 may be constructed to represent virtually any sound that is desired. For example, when a new instrument is to be introduced for use in templates 300, the administrative user may construct a sound generator 350 for that instrument. It should be understood that the same sound generator 350 may be used by a plurality of different templates 300, representing a plurality of different musical genres and sub-genres. Generally, sound generators 350 for common instruments, such as drums, bass, and the like, will be used more frequently than less common instruments or other sound sources.

In an embodiment, each sound generator 350 may represent the lowest level of a sound hierarchy. At the highest level of the sound hierarchy are musical genres (e.g., hip hop, RnB, etc.). At a lower level, each musical genre may have one or more sub-genres (e.g., trap, melodic rap, etc.). At an even lower level, each sub-genre may have one or more musical instrument groups (e.g., acoustic snare drums, electronic snare drums, etc.). At the lowest level of the sound hierarchy, each musical instrument group may have one or more sound generators 350. Thus, each sound generator 350 can be associated with a particular tuple of musical genre, sub-genre, and musical instrument group in the sound hierarchy. These associations may be implemented as tags, which are associated with each sound generator 350, representing each level of the sound hierarchy above the lowest level, such that sound generators 350 can be easily searched based on level(s) in the sound hierarchy (e.g., musical genre, sub-genre, and/or musical instrument group).

Similarly, each rhythm 370 may represent the lowest level of a rhythm hierarchy. At the highest level of the rhythm hierarchy are pattern types (e.g., melody pattern, chord pattern, etc.). At a lower level, each pattern type may have one or more musical genres and/or sub-genres (e.g., hip ho p, 80′s hip hop, etc.). At a lower level, each musical genre or sub-genre may have one or more instrument samples (e.g., electric plano, cymbal, etc.). At the lowest level of the rhythm hierarchy, each instrument sample may have one or more rhythms 370. Thus, each rhythm 370 can be associated with a particular tuple of pattern type, musical genre or sub-genre, and musical instrument sample. These associations may be implemented as tags, which are associated with each rhythm 370, representing each level of the rhythm hierarchy above the lowest level, such that rhythms 370 can be easily searched based on level(s) in the rhythm hierarchy (e.g., pattern type, musical genre or sub-genre, and/or musical instrument sample).

4. Example Process

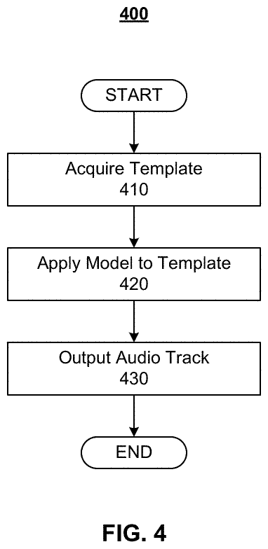

FIG. 4 illustrates a process 400 for automated generation of an audio track, according to an embodiment. Process 400 may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. Process 400 may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

While process 400 is illustrated with a certain arrangement and ordering of subprocesses, process 400 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 410, a template 300 is acquired. In an embodiment, one or more templates 300 may be predefined by an operator of platform 110. For example, an administrative user, representing the operator, may log in to an administrative account of server application 112 (e.g., from the agent's user system 130) to define a template 300. Alternatively, end users of platform 110 may have the ability to define individual templates 300 themselves. In this case, the end user may log in to a user account of server application 112 (e.g., from the end user's user system 130) to define a template 300. In yet another alternative, a portion of each template 300 may be predefined by the operator, while a remaining portion of each template 300 may be defined by an end user. In this case, the predefined portion of template 300 may be packaged with default values for the remaining portion of template 300, such that the end user is not required to specify any values unless the end user wishes to specify values. In any case, server application 112 may provide each user that has the ability to define a template 300, within the particular implementation, with a graphical user interface comprising one or more screens including inputs to define a template 300.

Subprocess 410 may comprise providing the screen(s) to the user and receiving the definition of template 300 via the inputs. Alternatively, subprocess 410 may comprise retrieving a predefined template 300 from database(s) 114. As yet another alternative, subprocess 410 may comprise retrieving a fully or partially predefined template 300 from database(s) 114, and displaying screen(s) to an end user to receive a change to, or completion of, at least a portion of template 300 via the inputs. In this case, default values may be provided for the portion of template 300 that can be changed or completed, such that the end user does not have to input any values if the end user does not wish to input any values. The default values may be provided as part of the predefined template 300. In an embodiment, the end user is only able to specify template parameter(s) 320 or a subset of parameter(s) 320, such as speed (e.g., beats per minute) and key.

In subprocess 420, a model is applied to the template 300, acquired in subprocess 410, to generate an audio track. The model represents a particular approach in music theory to generate an audio track, based on template parameter(s) 320, template section(s) 330, and the sound generator(s) 350 associated probabilistically with each template section 330 via probability vectors 340. For example, for each template section 330, the model may select one or more sound generators 350 associated with that template section 330 via probability vector 340, based on the probability values associated with those sound generator(s) 350 in probability vector 340. For each template section 330, the model may successively execute algorithm 390 associated with each selected sound generator 350, according to generator parameter(s) 355, source(s) 360, rhythm(s) 370, effect(s) 380, and algorithm parameter(s) 395, to generate audio samples. These audio samples may comprise a repeating musical pattern (e.g., drum beat, melody, etc.) or can be a one-shot (e.g., a single instance of a musical idea that does not repeat, such as a cymbal crash, background effect, etc.). These audio samples are joined together by the model into an audio section that represents the template section 330. It should be understood that, depending on the probability vector 340, not all sound generators 350 will necessarily be used for a given template section 330.

In subprocess 430, the audio track, generated by the model in subprocess 420, is output. The audio track may be rendered into any format for output. Output formats include, without limitation, Waveform Audio File Format (WAV), including a stem or composite WAV file, Moving Picture Experts Group (MPEG)-1 Audio Layer III or MPEG-2 Audio Layer III file format (MP3), or the like. In an embodiment, the end user may select the output format from a plurality of available output formats. The final audio track that is output by subprocess 430 may comprise the entire mix of sounds, optionally with a set of audio files (“stems”) representing each individual instrument in the audio track and MIDI files representing each unique note sequence.

The audio track, in the rendered output format, may be downloaded by the end user, stored in an online library of the end user (e.g., stored in database(s) 114 in association with the end user's user account), published to a social media feed associated with the end user's user account on a social networking platform (e.g., external system 140), posted to a website (e.g., external system 140), and/or the like.

In an embodiment, server application 112 enables the end user to name and store any rendered audio tracks in a library, associated with the end user's account, in database(s) 114. The end user may utilize the graphical user interface to view a list of all audio tracks in the end user's library, including, for example, the name of each audio track, one or more parameters of each audio track (e.g., genre, sub-genre, tempo, key, duration, etc.), the creation date of each audio track, an input for adding the audio track to a list of favorites associated with the end user, an input for playing the audio track and/or opening a playback dialog screen or box for playing the audio track, an input for sharing the audio track (e.g., via email message, text message, a file-sharing service, a social networking site, etc.), an input for downloading the audio track to the end user's user system 130 (e.g., in a selectable output format), and/or the like.

In an embodiment, the rendering of audio tracks in subprocess 430 may exist as a separate module from module(s) that implement subprocesses 410 and/or 420, such that the rendering is isolated and independently scalable and optimizable. For example, server application 112 may utilize a microservice architecture. In this case, server application 112 may comprise a collection of loosely coupled, fine-grained, independently deployable services that communicate via respective APIs and lightweight protocols. In this case, subprocess 420 may be implemented as a first microservice, and subprocess 430 may be implemented as a second microservice. An audio track can be generated by providing a template 300 to the first microservice via an API of the first microservice, and the audio track can be rendered into an output format by providing the audio track to the second microservice via an API of the second microservice. Advantageously, instances of either microservice and/or computing resources allocated to either microservice can be dynamically scaled up or down as needed, and independently of the other microservice.

Values for metadata 310 may also be generated with the audio track in subprocess 420 and/or associated with the audio track that is output in subprocess 430. The metadata values can be stored in a new data structure (e.g., in database(s) 114), using a no-SQL document-oriented database, such as MongoDBTM. These metadata values can be used to create granular instructions for playing the audio in the client application 132 (e.g., browser) of user system 130 of an end user. Thus, the user can preview the generated audio track prior to downloading or publishing the audio track.

5. Example Graphical User Interface

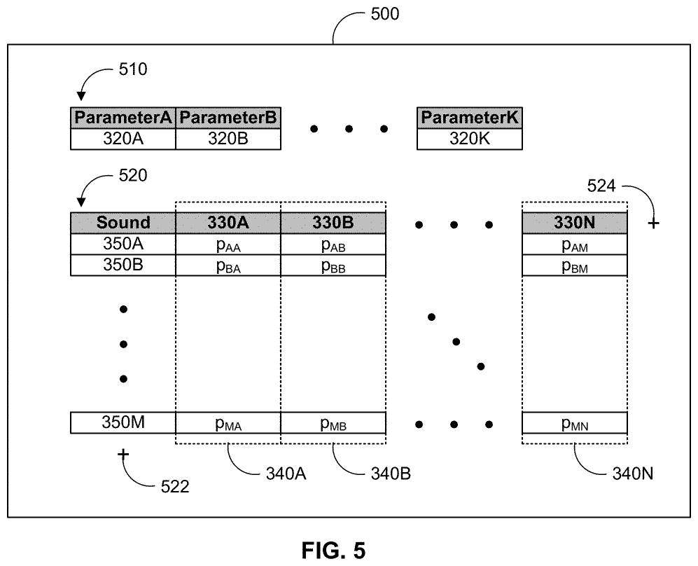

FIG. 5 illustrates an example screen 500 that may be used to define a template 300, according to an embodiment. A template 300 may be defined from a blank template, a generic template, an existing template, or the like. In the event that a template 300 is being defined from a generic or existing template, input fields in screen 500 may be pre-populated with default or existing values.

Screen 500 may be used in subprocess 410 to acquire a definition of the template 300 from an administrative user and/or an end user. Screen 500 may comprise one or more inputs 510 for specifying the values of each template parameter 320, illustrated as template parameters 320A, 320B, . . . , 320K, in which K may be any integer value greater than or equal to zero.

Screen 500 may also comprise a matrix 520 for defining a probability vector 340 for each template section 330 and sound generator 350. Each row in matrix 520 may represent a sound generator 350, illustrated as sound generators 350A, 350B, . . . , 350M, in which M may be any integer value greater than zero. Each column in matrix 520 may represent a template section 330, illustrated as template sections 330A, 330B, . . . , 330N, in which N may be any integer value greater than zero. In particular, each column in matrix 520 represents a probability vector 340 for the corresponding template section 330. For example, the column for template section 330B represents the probability vector 340B for template section 330B.

It should be understood that, in an alternative embodiment, the rows and columns in matrix 520 may be switched, such that template sections 330 and their associated probability vectors 340 are represented by rows and sound generators 350 are represented by columns. More generally, matrix 520 comprises two dimensions, with a first dimension representing each sound generator 350 associated with the template 300, and a second dimension representing each template section 330 associated with the template 300. Probability vectors 340 correspond to template sections 330 along the second dimension.

The user may also add or remove rows and/or columns from matrix 520. For example, screen 500 may comprise an input 522 for adding a new row and specifying a new sound generator 350. For example, when a user selects input 522, a screen or pop-up dialog box for selecting a sound generator 350 from a list of sound generators 350 may be displayed. When a user selects a sound generator 350 from the list of sound generators 350, a new row may be added to matrix 520 for the selected sound generator 350.

Similarly, screen 500 may comprise an input 524 for adding a new column and specifying a new template section 330. For example, when a user selects input 524, a new column may be added to matrix 520 with an input for naming the template section 330. Although not shown, other inputs may be provided for reordering template sections 330, reordering sound generators 350, defining probabilities for template sections 330, and/or the like. It should be understood that template sections 330 may represent discrete audio sections of a musical composition, such as an introduction, one or more verses, one or more choruses, an outro, and/or the like.

The order of template sections 330 in the columns of matrix 520 for a template 300 may define the order of template sections 330 in any audio track that is generated from that template 300. It should be understood that the number and order of template sections 330 will vary, depending on the musical genre, sub-genre, desired usage, and/or the like. Alternatively, the template sections 330 may be defined probabilistically, such that the selection of which template sections 330 are included, the order of included template sections 330, the number of each included template section 330, and/or the like may be determined during generation of the audio track from template 300.

Each cell in matrix 520 corresponds to a particular template section 330 and a particular sound generator 350. Each cell in matrix 520 may comprise an input for specifying a probability value by which the corresponding sound generator 350 is to be used in the corresponding template section 330. For example, probability value pBA represents the probability that sound generator 350B will be used for creation of the audio sample for template section 330A. Thus, each probability vector 340 comprises the probability that each sound generator 350 will be used to generate the corresponding template section 330.

Although not illustrated, in an embodiment, sound generators 350 may be grouped together. When a sound generator 350 is grouped with one or more other sound generators 350, only one sound generator 350 from that group may be selected for a particular template section 330 when generating an audio track from template 300. When sound generators 350 are grouped, the probability values in probability vector 340 effectively become weights that can be used for selecting a sound generator 350 from the group during generation of an audio track from template 300. Sound generators 350 may be grouped within screen 500 via an input that is associated with each sound generator 350. For example, a column may be added to matrix 520 that comprises an input for specifying a group name for each sound generator 350 (i.e., for each row in matrix 520). Sound generators 350 with the same group name may be determined to be within the same group, whereas sound generators 350 with different group names are within different groups. Sound generators 350 with no group name may be treated as being in the same group or individual groups.

Each sound generator 350 may be predefined via a graphical user interface, provided by server application 112, such that it is selectable when defining template 300. For example, the graphical user interface may comprise one or more screens with inputs for selecting source(s) 360, rhythm(s) 370, effect(s) 380, and algorithm 390, as well as generator parameter(s) 355 and algorithm parameter(s) 395, and saving the selected components as a sound generator 350. Sound generators 350 may be stored in database(s) 114, and may each be selectable from a list of sound generators 350 when defining matrix 520 (e.g., when selecting input 522). In an embodiment, only administrative users, representing the operator of platform 110, may define sound generators 350. In an alternative embodiment, end users may be permitted to define sound generators 350.

As discussed elsewhere herein, each source 360 may comprise a sample bank. In an embodiment, a user (e.g., an administrative user) may view a library of sources 360 stored in database(s) 114 via a graphical user interface provided by server application 112. The user may select one of the sources 360 in the library, via the graphical user interface, to view details about the selected source 360. For example, if the user selects a source 360 from the library, the graphical user interface may provide a list of audio files in the sample bank of the selected source 360. The list of audio files may comprise details about each audio file, including the length of the audio file, the filename, and/or the like, as well as one or more inputs for playing the audio file. The user may also select an audio file from the list of audio files, via the graphical user interface, to view further details about the selected audio file, such as type, repeats per note, low note, high note, note spacing, beats per minute, and/or the like.

6. Example Model

At a high level, subprocess 420 of process 400 generates patterns based on inputs, including template parameters 320. The model uses these patterns to generate an audio track, note by note and section by section, using the sound generator(s) 350 that are probabilistically associated with each template section 330. Subprocess 420 may comprise a series of decision points. At each decision point, until the audio track is complete, the model's task is to append a new note to the audio track. Advantageously, by using one-shots to build an audio track, note by note, disclosed embodiments do not utilize pre-built loops, which may infringe an existing copyright. Thus, in addition to providing automated generation of audio tracks, disclosed embodiments may also negate any claims of copyright infringement by independently constructing each musical composition. However, it should be understood that this is not a necessity of any embodiment, and that the model may construct audio tracks using loops. More generally, the model may construct audio tracks using only one-shots, only loops, or a combination of one-shots and loops. In a particular implementation, the model may construct the melody using only one-shots, but construct other components of the audio track using one-shots, loops, or a combination of one-shots and loops.

In an embodiment in which template sections 330 have fixed durations and a fixed order, the model may execute the sound generator(s) 350 to produce audio sections of the fixed durations for all template sections 330. These audio sections can be joined in their defined order, to generate the overall audio track. Thus, the audio track will comprise an audio section for each template section 330 in the template 300 from which the audio track is generated. In this case, audio tracks that are generated from the same template 300 will have the same structure in terms of the presence, duration, and/or order of audio sections, but will generally differ in terms of the sound of each audio section.

In an alternative embodiment in which template sections 330 have defined probabilities, an arrangement of template sections 330 may be probabilistically determined, the model may execute the sound generator(s) 350 to produce audio sections for each template section 330 in the arrangement, and these audio sections may be joined according to the arrangement to generate the overall audio track. In other words, the arrangement of template sections 330 within an audio track can be randomized. In this case, audio tracks that are generated from the same template 300 may have different structures in terms of the number, durations, and/or order of template sections 330, in addition to differences in the sound of each audio section.

Regardless of how the template sections 330 are defined, subprocess 420 may utilize the probability vector 340 associated with each template section 330 to determine which sound generator(s) 350 to use to generate the audio section for that template section 330. It should be understood that different audio sections may be generated for the same template section 330 in the same template 300 in different executions of subprocess 420, whether for different users or the same user. In other words, two different executions of process 400 for the same template 300 may produce two completely different audio tracks, albeit in the same musical genre, even for templates 300 with fixed template sections 330. This is because the sound generator(s) 350 selected by the model during different executions of subprocess 420 may differ due to the probability vector 340, different patterns may be generated during different executions, different effects may applied during different executions, and/or the like.

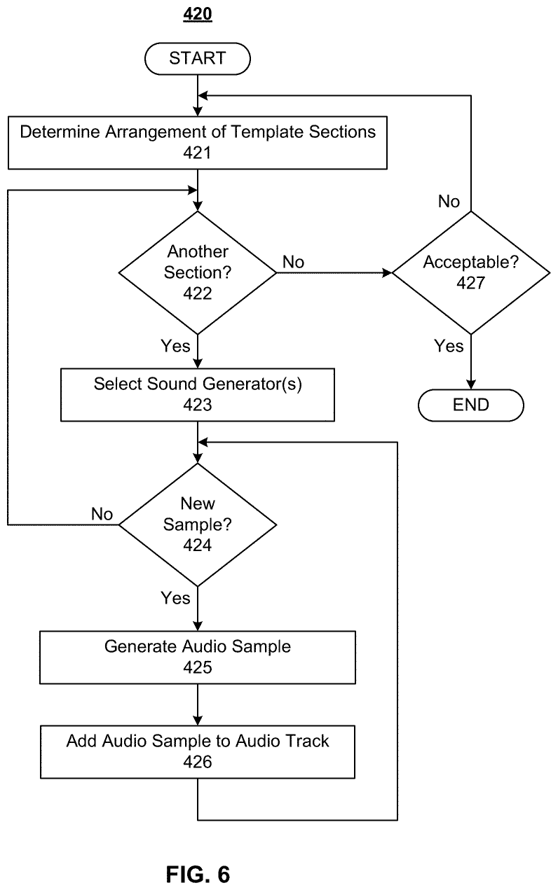

FIG. 6 illustrates an example of subprocess 420, which applies the model to a template 300 to generate an audio track, according to an embodiment. In this example, the model may comprise one or more components, including potentially both heuristic and machine-learning components, that are used at one or more points in subprocess 420, as discussed in further detail below.

In subprocess 421, the arrangement of template sections 330 is determined. Subprocess 421 may comprise determining which template sections 330 to include, how many of each template section 330 to include (e.g., the number of verses, the number of choruses, etc.), the order of the template sections 330 that are to be included, the duration of each template section 330 that is to be included, and/or the like, based on probabilities for the template sections 330 defined in template 300. In an alternative embodiment in which template sections 330 are fixed, subprocess 421 may simply comprise retrieving the arrangement of template sections 330, defined in template 300, from database(s) 114.

In subprocess 422, it is determined whether or not an audio section needs to be generated for the audio track from another template section 330, according to the arrangement determined in subprocess 421. When another audio section needs to be generated (i.e., “Yes” in subprocess 422), the next template section 330 within the arrangement is selected as the current template section 330, and subprocess 420 proceeds to subprocess 423. Otherwise, once all audio sections have been generated (i.e., “No” in subprocess 422), subprocess 420 proceeds to subprocess 427.

In subprocess 423, one or more sound generators 350 are selected from the sound generators 350 that are associated with the current template section 330, based on the probability vector 340 associated with the current template section 330. For example, for each sound generator 350 associated with the current template section 330, it is determined whether or not that sound generator 350 will be used in the current template section 330, based on the probability value for that sound generator 350 in the probability vector 340 for the current template section 330.

In subprocess 424, it is determined whether or not a new audio sample is to be generated for the current template section 330. It may be determined that a new audio sample is to be generated for the current template section 330 whenever the duration of the audio section that has been generated so far for the current template section 330 (i.e., in prior iterations of subprocesses 424-426) is less than the duration of the template section 330 in the arrangement determined in subprocess 421. When another audio sample is to be generated (i.e., “Yes” in subprocess 424), subprocess 420 proceeds to subprocess 425. Otherwise, when the audio section generated for the current template section 330 is complete (i.e., “No” in subprocess 424), subprocess 420 returns to subprocess 422 to determine whether or not an audio section for another template section 330 needs to be generated.

In subprocess 425, a new audio sample is generated from the sound generator(s) 350 that were selected for the current template section 330 in subprocess 423. For example, for each selected sound generator 350, the algorithm 390 may be executed, according to algorithm parameter(s) 395, to produce a sound from source(s) 360, according to rhythm(s) 370, any effect(s) 380, and generator parameter(s) 355 for that sound generator 350. Since the inputs to algorithm 390 have an element of randomness, the sound produced by each sound generator 350 will also have an element of randomness. In other words, each sound generator 350 will produce a unique sound for each execution of its respective algorithm 390. Further variability can be introduced to each template 300 by adding audio files to the sample bank of one or more sources 360 to thereby increase the number of different sounds that can be used, adding sources 360 to template 300 to thereby increase the variation in sound selection, adding rhythms 370 to template 300 to thereby increase the number of different note sequences that can be used, adding effects 380 to template 300, randomizing effects 380 associated with template 300, probabilistically defining template sections 330 in template 300, adjusting algorithm 390 to generate a wider range of note sequences in different styles and genres, and/or the like.

In subprocess 425, the model may be applied to the combination of the previously generated portion of the audio track (i.e., the current audio track as derived from prior iterations of subprocesses 422-426) appended with the output of the selected sound generator(s) 350. In this case, the output of the selected sound generator(s) 350 may comprise a combination of the outputs from all of the selected sound generator(s) 350. Alternatively, the model could incrementally combine the output of each selected sound generator 350 with the current audio track, and apply the model after each combination.

The model may alter the output of the selected sound generator(s) 350 to fit the current audio track, according to template parameter(s) 320. In particular, the model may fit the output of the selected sound generator(s) 350, which may be a one-shot, to the position, notes, instruments, and/or the like in the current audio track. The altered output of the selected sound generator(s) 350 may represent a potential next note to be added to the current audio track.

The model may comprise a scoring function that determines a score for the combination of the current audio track with the output of the selected sound generator(s) 350 appended to the end of the current audio track. The score represents a quality of the melody in the combined audio track, which may be derived by evaluating attributes, such as chord progression, note length factor (e.g., favoring longer or shorter notes), musical scale (e.g., diatonic, pentatonic, etc.), note range, note length, melody length, and/or the like. The scoring function may reward one or more attributes (e.g., increase the score when the attribute(s) are present, or decrease the score when the attribute(s) are absent) and/or penalize one or more attributes (e.g., decrease the score when the attribute(s) are present, or increase the score when the attribute(s) are absent). In general, melodies that follow the rules of the applicable music theory are rewarded, whereas melodies that do not follow the rules of the applicable music theory are penalized. The music theory defines how notes should be connected together. Examples of attributes that may be rewarded include, without limitation, symmetry with respect to two-bar units of time, symmetry with respect to one-bar units of time, and/or the like. Examples of attributes that may be penalized include, without limitation, too many consecutive repeated notes, too much repetition throughout the overall melody, excessive distance between consecutive notes, multiple consecutive large jumps, not enough notes on down beats, too many notes that do not match the current chord in the progression, and/or the like.

In an embodiment, the model may generate a plurality of alternative outputs from the selected sound generator(s) 350, representing a set of candidate notes to be added to the current audio track. These alternative outputs may be generated randomly. The model may execute the scoring function to determine the score for each combination of the current audio track with one of the candidate notes. Then, the model may select one of the candidate notes to be added to the current audio track, based on the scores. For example, the model may select the candidate note which produced the highest score when combined with the current audio track.

Alternatively, to introduce additional variability into the process, the model may derive a list of a plurality of candidate notes based on their respective scores (e.g., the candidate notes that produced the top S scores, where S >1), and select one of the candidate notes from this list based on a selection mechanism other than simply selecting the candidate note that produced the highest score (e.g., random selection). This can ensure that, even if, by chance, two audio tracks start out exactly the same, they will eventually diverge to produce two unique melodies. For instance, if an audio track comprises ten notes and S=10, the likelihood of two applications of the model producing identical audio tracks in two executions of process 400 would be one in ten billion. In reality, audio tracks will generally comprise much more than ten notes. Furthermore, this ignores the variability in the sound generation discussed elsewhere herein, as well as the variability in the arrangement of template sections 330 in embodiments which define template sections 330 probabilistically, which further decrease the likelihood of identical audio tracks being produced.

In an alternative embodiment, the model may be an optimization model that implements an optimization problem. In this case, the scoring function may represent an objective function, and the score, output by the scoring function, may represent a target value to be optimized. In an embodiment in which a higher target value represents a higher quality melody, optimizing the target value comprises maximizing the target value, which may be mathematically expressed as:

$${max}_{x} ( f ( x ) + {\sum }^{I} {g}_{i} ( x ) ) , I \geq 0$$

wherein max is a maximization function, f (x) is the primary objective function, x is the set of value(s) for one or more variables, each g (x) represents a secondary objective function, and I represents the number of secondary objective functions g (x) . The set of variable value(s) x may comprise features of the candidate note and/or the current audio track, and f (x) represents a measure of quality of the audio track with the candidate note given the set of variable value(s) x. The model may also be subject to one or more constraints that prevent certain values or attributes in the set of variable value(s) x. For example, the note range may be constrained to prevent notes that are below a threshold and/or above a threshold, the note length may be constrained to prevent notes that are shorter than a threshold and/or longer than a threshold, and/or the like.

It should be understood that, in an alternative embodiment in which a lower target value represents a higher quality audio track, the optimization may be expressed as a minimization problem:

$${min}_{x} ( f ( x ) + {\sum }^{K} {g}_{k} ( x ) ) , K \geq 0$$

However, in order to simplify the description, it will generally be assumed herein that the optimization problem is cast as a maximization problem. A person of skill in the art will understand how to convert between a maximization and minimization problem, and which problem may be more appropriate in a given circumstance.

In any case, the optimization model may comprise zero, one, or a plurality of objective functions g (x) . In a maximization problem, a secondary objective function g(x) may penalize one or more attributes of the set of variable value(s) x by subtracting from the target value that is output by primary objective function f (x), in the same unit of measure (e.g., quality score) as primary objective function f (x) . Such penalization serves to bias the optimization away from solutions with a set of variable value(s) x that have those attribute(s). Alternatively, in a maximization problem, a secondary objective function g(x) may reward one or more attributes of variable value(s) x by adding to the target value that is output by primary objective function f (x), in the same unit of measure (e.g., quality score) as primary objective function f (x) . In contrast to penalization, rewarding serves to bias the optimization towards solutions with a set of variable value(s) x that have those attribute(s). Examples of attributes that may be penalized or rewarded are discussed above. The secondary objective function(s) g(x) may be weighted to ensure balance, such that no single attribute dominates.

The optimization model may be solved by determining the set of variable value(s) x that optimize (e.g., maximize) the target value, as the sum of the primary objective function f (x) with any secondary objective functions g (x) . Solving the optimization model may comprise iteratively executing objective function f (x) and any secondary objective functions g (x), subject to any constraints, using a different set of variable value(s) x in each iteration until the target value converges. After each iteration, the set of variable value(s) x for the next iteration may be determined using any known technique (e.g., gradient descent). The target value may be determined to converge when it is within a tolerance from a specific value, when the rate of improvement to the target value over prior iterations satisfies a threshold (e.g., the rate of change in the target value falls below a threshold), and/or when one or more other criteria are satisfied. Once the target value has converged, the set of variable value(s) x that produced the final target value may be output as the solution to the optimization model. This set of variable value(s) x may represent the next note to be added to the current audio track.

In an embodiment, the optimization model is a machine-learning model. For example, primary objective function f (x) may be trained using supervised machine-learning. In this case, a training dataset of (X, Y), in which X represents sets of values for the variable(s) and Y represents ground-truth target values for each of those sets of values for the variable(s), may be used. The training dataset (X, Y) may be derived from known melodies with known qualities. The training may be expressed as:

min(Y−f(X))

wherein primary objective function f (X) (e.g., the weights in the primary objective function f (X)) is updated to minimize the error between the ground-truth target values Y and the corresponding target values output by f (X) . Alternatively, primary objective function f (x) may be trained in other manners. Any secondary objective functions g (x) may be trained in a similar or identical manner, either separately or in combination with primary objective function f (x) .

Regardless of how the next note is derived in subprocess 425, the output of subprocess 425 is an audio sample representing that next note. In subprocess 426, this audio sample is added to the current audio track 426. For example, the audio sample may be appended to the end of the current audio track 426. Then, subprocess 420 may return to subprocess 424 to determine whether or not another audio sample needs to be generated.

In subprocess 427, it is determined whether or not the audio track, which has been automatically generated over a plurality of iterations of subprocesses 421-426, is acceptable. For example, the current audio track may be played back through a graphical user interface provided by server application 112. In an embodiment, a script of the graphical user interface is executed to play the current audio track back, for example, in real time as the audio track is being generated. An example of such a script is Tone.js, which is a JavaScript-based framework for creating interactive music in a web browser. However, any other script, including any other lightweight JavaScript-based audio engine capable of temporarily rendering the current audio track, may be used. The end user may listen to the playback to determine whether or not the audio track is acceptable.

When the audio track is acceptable to the end user, the end user may perform a user operation that confirms or implies that the audio track is acceptable, such as selecting an input in the graphical user interface to save the audio track to the end user's library, publish the audio track to an external system 140 (e.g., social networking site), download the audio track, send the audio track to at least one recipient via email message or text message (e.g., Multimedia Messaging Service (MMS) message), and/or the like. In this case, subprocess 427 determines that the audio track is acceptable (i.e., “Yes” in subprocess 427), and proceeds to subprocess 430 to render and output the final audio track.

When the audio track is not acceptable to the end user, the end user may perform a user operation that confirms or implies that the audio track is not acceptable. The graphical user interface may comprise one or more inputs for adjusting one or more template parameters 320 (e.g., key, beats per minute, duration, etc.) and/or template sections 330, and regenerating an audio track. The end user may utilize these input(s) to adjust template parameters 320 and/or template sections 330 and regenerate the audio track. In this case, subprocess 427 determines that the audio track is not acceptable (i.e., “No” in subprocess 427), and returns to subprocess 421 to generate a completely new audio track based on the same template 300. Alternatively, the end user could abandon the process by switching to a different template 300, in which case process 400 would be executed for the new template 300, exiting client application 132 (e.g., closing the end user's browser), navigating to a different screen of the same or a different graphical user interface, and/or the like.

7. Sound-Specific Algorithms

In an embodiment, the model may comprise different algorithms for different types of sounds, such as particular instruments, according to a specific music theory for that type of sound. In this case, different algorithms may be applied in subprocess 425 to the outputs of different sound generators 350, depending on the musical instrument group to which each sound generator 350 belongs.

As one example, the model could comprise a specific algorithm for generating guitar notes that may be applied to each sound generator 350 that is associated with a guitar in the musical instrument group of the sound hierarchy. This algorithm may create more realistic guitar notes than basic sampling using a plano roll, by replicating the manner in which a human's hand actuates the guitar strings. In particular, the algorithm may prevent the selection of a note, for addition to the current audio track, that would be outside the realistic bounds of human fingers (e.g., given the preceding note).

As illustrated in the below table, unlike for a plano, there are multiple locations on the neck of the guitar to play a given note. For example, E4 can be played at three locations in the first twelve frets of the guitar. At different locations, the same note will have a slightly different timbre, due to the different gauge of the string and the fretting location. Similarly, there may be different locations on the neck of the guitar to play the same chord. Each location may have a different sound, due to the difference in voicing.

Frets

| 0 | 1 | 2 | 3 | 4 | 5 | 6 | 7 | 8 | 9 | 10 | 11 | 12 |
|---|---|---|---|---|---|---|---|---|---|---|---|---|
| E4 | F4 | F#4 | G4 | G#4 | A4 | A#4 | B4 | C5 | C#5 | D5 | D#5 | E5 |
| B3 | C4 | C#4 | D4 | D#4 | E4 | F4 | F#4 | G4 | G#4 | A4 | A#4 | B4 |
| G3 | G#3 | A3 | A#3 | B3 | C4 | C#4 | D4 | D#4 | E4 | F4 | F#4 | G4 |
| D3 | D#3 | E3 | F3 | F#3 | G3 | G#3 | A3 | A#3 | B3 | C4 | C#4 | D4 |
| A2 | A#2 | B2 | C3 | C#3 | D3 | D#3 | E3 | F3 | F#3 | G3 | G#3 | A3 |
| E2 | F2 | F#2 | G2 | G#2 | A2 | A#2 | B2 | C3 | C#3 | D3 | D#3 | E3 |

To create realistic guitar melodies, the guitar-specific algorithm may select a rhythm 370, choose a random location on the neck of the guitar for the first note, and then use a scoring function, as described elsewhere herein, to select the location of the next note on the neck of the guitar. Each next note may be selected to emulate the choices a guitarist could realistically make, based on how far a guitarist's hand or fingers are able to move to fret each note.

To create realistic chord shapes and voicings, the guitar-specific algorithm may pull from a sample bank of voicings (e.g., stored manually in database(s) 114). The sample bank of voicings may be comprehensive and include all potential voicings for the genre of template 300. The guitar-specific algorithm may pass a reference to this sample bank of voicings to a sound generator 350 (e.g., in subprocess 425). The guitar-specific algorithm may evaluate the global chord progression of the current template section 330 to find a matching chord for each chord in the global chord progression.

To increase the realism of the guitar melody, a multi-velocity sample function may be used. The multi-velocity sample function produces audio samples with any amount of different velocities and round-robin notes. Similarly, one or more other functions may be used to produce randomized strum patterns, fret noises, finger sliding, and/or other humanizations in the audio samples for guitars.

It should be understood that similar functions for humanizing instrument sounds may be implemented for other types of instruments. In all cases, these humanization functions may be toggleable user settings that can be enabled or disabled during construction of the respective template 300 and stored as template parameters 320.

8. Example Embodiment

In a contemplated embodiment, an administrative user would log in to an administrative-user account with server application 112. The administrative user would design a template 300 using a screen of a graphical user interface provided by server application 112, such as screen 500. One or more administrative users may design a plurality of templates 300 in this manner, which may be stored in database(s) 114 for subsequent retrieval. Each of the plurality of templates 300 may represent an interpretation of a particular musical genre or sub-genre.

The graphical user interface of server application 112 may have end-user facing screens that enable end users to select a particular template 300 from the plurality of templates 300 stored in database(s) 114. For example, the screen(s) may comprise lists of templates 300 that are selected or ordered according to preferences or settings of the end user, recommendations for the end user generated by a recommendation engine, popularity, genres and/or sub-genres (e.g., alphabetically, hierarchically, etc.), randomly, and/or the like.

The end user may select one of the templates 300 from the list of templates 300 to initiate process 400 for automated generation of an audio track. In particular, within the list of templates 300 or after selecting a template 300, the graphical user interface may provide one or more inputs for generating an audio track from the selected template 300. When the end user selects a template 300 from the list of templates 300, the data structure for template 300 may be retrieved from database(s) 114. The one or more inputs may also include input(s) for adjusting one or more template parameters 320. In an embodiment, the adjustable template parameters 320 have default values (e.g., values predefined for template parameters 320) and are only a subset of the full template parameters 320. For example, the adjustable template parameters 320 may comprise speed, which may be adjusted using a slider and/or a textbox that accepts a number representing the beats per minute, and the key, which may be adjusted by selecting a new key from a drop down or key diagram and/or toggling between major and minor. Thus, the end user may change the adjustable template parameters 320, if and as desired. The one or more inputs may also include a textbox for specifying a name for the audio track that is generated from the selected template 300. It should be understood that the retrieval of the selected template 300 from database(s) 114 and the reception of adjusted parameters, if any, correspond to subprocess 410 of process 400.

Next, the end user may select the input for generating the audio track, at which point server application 112 may generate the audio track. The end user may adjust parameters and generate the audio track over one or a plurality of iterations until the end user is satisfied with the audio track (e.g., until “Yes” in subprocess 427) or abandons the process. Once an audio track has been generated, the graphical user interface may provide an additional input for saving the audio track. It should be understood that the generation of the audio track corresponds to subprocess 420 of process 400.

Once the end user is satisfied with the audio track (e.g., “Yes” in subprocess 427), the end user may save the audio track to the end user's library (e.g., stored in database(s) 114). At this point, the audio track may represent a coarse preview. However, when the end user chooses to download or share the audio track from their library, server application 112 may mix and master the audio track into a final audio file that can be downloaded and/or shared. It should be understood that the saving and/or downloading/sharing of the audio track corresponds to subprocess 430 of process 400.

As mentioned elsewhere herein, server application 112 may comprise a first microservice that implements subprocess 420 to generate the audio track, and a second microservice that implements subprocess 430 for rendering the generated audio track into a final audio file. The first and second microservices may operate independently and be elastically scaled independently from each other, to provide more flexibility and efficiency in the utilization of computational resources of platform 110.

It should be understood that a plurality of different end users may all utilize the same template 300 to generate entirely different audio tracks. As discussed throughout the present disclosure, variability is built into process 400 at multiple points. These multiple points of variability may be increased or decreased, as desired. However, it is generally contemplated that the overall variability will be sufficient to ensure that it is practically impossible for different executions of process 400 to ever produce identical audio tracks, even over the millions, billions, or trillions of executions that are enabled by the utilization of templates 300.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B′s, multiple A′s and one B, or multiple A′s and multiple B′s.

What is claimed is:

1. A method comprising using at least one hardware processor to:
acquire a template, wherein the template comprises one or more template sections that are each associated with one or more sound generators;
apply a model to the template to generate an audio track from the template by, for each of at least a subset of the one or more template sections, generate an audio section, note by note, using at least a subset of the one or more sound generators associated with that template section; and
output the audio track in an output format.

2. The method of claim 1, wherein each of the one or more template sections is associated with a probability vector that defines a probability value for each of the one or more sound generators associated with that template section.

3. The method of claim 2, wherein each probability value for one of the one or more sound generators in each probability vector represents a likelihood that the sound generator will be used to generate the audio section for the template section associated with that probability vector.

4. The method of claim 1, wherein the template comprises one or more template parameters, and wherein the model generates the audio track according to the one or more template parameters.

5. The method of claim 4, wherein the one or more template parameters comprise one or both of a speed or a musical key.

6. The method of claim 1, wherein the one or more template sections are a plurality of template sections.

7. The method of claim 6, further comprising using the at least one hardware processor to determine an arrangement of the plurality of template sections.

8. The method of claim 7, wherein the plurality of template sections are associated with probability values, and wherein the at least one hardware processor determines the arrangement of the plurality of template sections based on the probability values.

9. The method of claim 1, wherein the one or more sound generators, associated with each of the one or more template sections, are a plurality of sound generators.

10. The method of claim 1, wherein each of the one or more sound generators, associated with each of the one or more template sections, is defined by one or more sources, one or more rhythms, and an algorithm that generates a one-shot, representing a note, based on the one or more sources and the one or more rhythms.

11. The method of claim 10, wherein each algorithm is associated with one or more algorithm parameters, and wherein each algorithm generates the one-shot according to the one or more algorithm parameters.

12. The method of claim 10, wherein at least one of the one or more sound generators, associated with at least one of the one or more template sections, is associated with one or more effects, and wherein the algorithm of the at least one sound generator generates the one-shot to have at least one of the one or more effects.

13. The method of claim 1, wherein the template represents a sub-genre of a musical genre.

14. The method of claim 1, wherein acquiring the template comprises:
receiving a selection of the template from a plurality of templates stored in a database; and
retrieving the template from the database.

15. The method of claim 14, wherein the template comprises one or more template parameters, wherein the model generates the audio track according to the one or more template parameters, and wherein acquiring the template further comprises:
generating a graphical user interface that comprises one or more inputs for specifying a value of each of at least a subset of the one or more template parameters; and
receiving the value of at least one template parameter via the one or more inputs.

16. The method of claim 14, further comprising using the at least one hardware processor to, for each of the plurality of templates:
generate a screen with one or more inputs for defining the template;
receive a definition of the template via the one or more inputs; and
store the defined template in the database.

17. The method of claim 16, wherein the screen comprises a matrix with two dimensions, wherein a first one of the two dimensions represents each sound generator that is associated with the one or more template sections, and wherein a second one of the two dimensions represents each of the one or more template sections.

18. The method of claim 1, wherein applying the model is implemented by a first microservice, and wherein outputting the audio track comprises rendering the audio track by a second microservice that is independent from the first microservice.

19. A system comprising:
at least one hardware processor; and
software that is configured to, when executed by the at least one hardware processor,
acquire a template, wherein the template comprises one or more template sections that are each associated with one or more sound generators,
apply a model to the template to generate an audio track from the template by, for each of at least a subset of the one or more template sections, generate an audio section, note by note, using at least a subset of the one or more sound generators associated with that template section, and
output the audio track in an output format.

20. A non-transitory computer-readable medium having instructions stored therein, wherein the instructions, when executed by a processor, cause the processor to:
acquire a template, wherein the template comprises one or more template sections that are each associated with one or more sound generators;
apply a model to the template to generate an audio track from the template by, for each of at least a subset of the one or more template sections, generate an audio section, note by note, using at least a subset of the one or more sound generators associated with that template section; and
output the audio track in an output format.
